(19) United States
(12) Patent Application Publication
(10) Pub. No.: US 2015/0298413 A1
(43) Pub. Date: Oct. 22, 2015

(54) MOLD ASSEMBLY WITH A PLURALITY OF REPLACEABLE INSERT ASSEMBLIES

(71) Applicant: Teng-Jen YANG, Taichung City (TW)

(72) Inventor: Teng-Jen YANG, Taichung City (TW)

(21) Appl. No.: 14/253,944

(22) Filed: Apr. 16, 2014

(51) Int. Cl. B29D 35/00; B29C 33/30; B29C 33/00

(52) U.S. Cl. CPC B29D 35/0081; B29C 33/0022; B29C 33/306

(57) ABSTRACT

A mold assembly with a plurality of replaceable insert assemblies includes a mold base with a first mold plate and a second mold plate. Each of the plurality of insert assemblies includes a female insert and a male insert, at least two of the insert assemblies have their female inserts removably disposed at an inner side of the second mold plate of the mold base, and have their male inserts removably disposed at an inner side of the first mold plate. On the mold base are provided at least two insert assemblies which can be replaced easily to meet different manufacturing needs. Besides, the mold base is provided with at least two insert assemblies, which reduces the number of times that the insert assemblies have to be replaced, so as to save labor while improving manufacturing efficiency.

### BACKGROUND OF THE INVENTION

1. Field of the Invention

The present invention relates to a mold assembly, and more particularly to a mold assembly with a plurality of replaceable insert assemblies.

2. Description of the Prior Art

FIGS. 1 and 2 show a conventional mold assembly with quickly replaceable mold plates, wherein the mold assembly 10 is provided with different replaceable insert assemblies 11, and each insert assembly 11 includes a male insert 111 and a female insert 112. The mold assembly can be used to produce different products simply by replacing different insert assemblies 11 without having to change the mold base.

However, when producing products in pairs, such as insoles, the conventional mold assembly will produce a pair of insoles at a time. When only one of the pair products needs to be produced (such as the left insole), the right side insole has to be produced together with the left side insole and will be discarded, which is very wasteful.

The present invention has arisen to mitigate and/or obviate the afore-described disadvantages.

### SUMMARY OF THE INVENTION

The primary objective of the present invention is to provide a mold assembly with a plurality of replaceable insert assemblies, wherein the insert assemblies 30 can be grouped freely and replaced easily according to different manufacturing needs, so as to produce different products of different specifications, sizes or styles at a time.

To achieve the above objective, a mold assembly with a plurality of replaceable insert assemblies in accordance with the present invention comprises: a mold base with a first mold plate and a second mold plate. Each of the plurality of insert assemblies includes a female insert and a male insert, at least two of the insert assemblies have their female inserts removably disposed at an inner side of the second mold plate of the mold base, and have their male inserts removably disposed at an inner side of the first mold plate.

The advantage of the present invention is that on the mold base are provided at least two insert assemblies which can be replaced easily to meet different manufacturing needs. Besides, the mold base is provided with at least two insert assemblies, which reduces the number of times that the insert assemblies have to be replaced, so as to save labour while improving manufacturing efficiency.

### BRIEF DESCRIPTION OF THE DRAWINGS

FIG. 1 is a cross sectional view of a conventional mold assembly;

FIG. 2 is a top view of the conventional mold assembly;

FIG. 3 is a cross sectional view of a mold assembly with a plurality of replaceable insert assemblies in accordance with a preferred embodiment of the present invention;

FIG. 4 is a top view of the mold assembly with a plurality of replaceable insert assemblies in accordance with a preferred embodiment of the present invention;

FIG. 5 is a top view of the present invention showing that the insert assemblies are used to produce two left insoles of the same pair of shoes at a time;

FIG. 6 is a top view of the present invention showing that the insert assemblies are used to produce two right insoles of the same pair of shoes at a time;

FIG. 7 is a top view of the present invention showing that the insert assemblies are used to produce two left insoles of different sizes at a time; and

FIG. 8 is a top view of the present invention showing that four insert assemblies of different sizes are fixed on the mold base, which are three left-insole insert assemblies and one right-insole insert assembly.

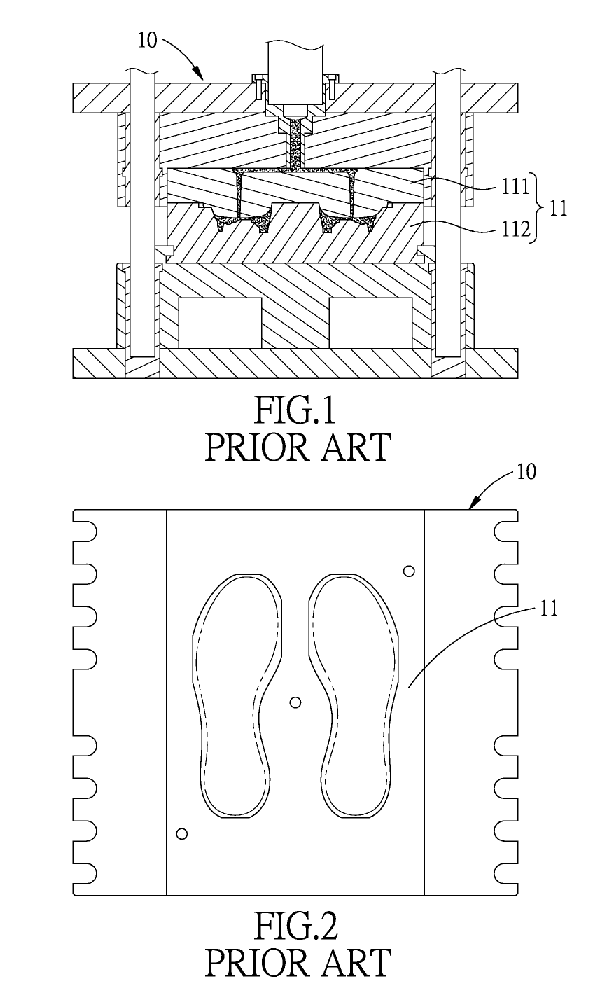

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

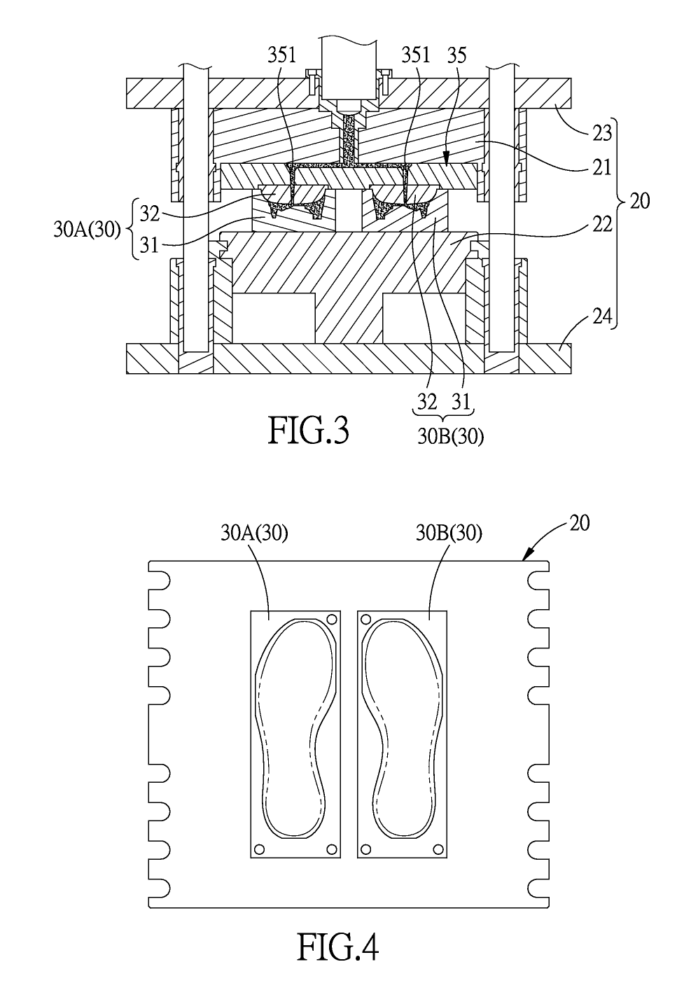

Referring to FIGS. 3-4, a mold assembly with a plurality of replaceable insert assemblies in accordance with a preferred embodiment of the present invention comprises: a mold base 20 and the plurality of replaceable insert assemblies 30. In this embodiment, the mold insert assemblies 30 used to produce insoles.

The mold base 20 includes a first mold plate 21 and a second mold plate 22. The first mold plate 21 is fixed to a first connecting board 23, and the second mold plate 22 is fixed to a second connecting board 24.

Each of the insert assemblies 30 includes a female insert 31 and a male insert 32. At least two (insert assemblies 30A, 30B) of the insert assemblies 30 have their female inserts 31 removably disposed at an inner side of the second mold plate 22 of the mold base 20, and have their male inserts 32 removably disposed at an inner side of the first mold plate 21. There are two insert assemblies 30A, 30B disposed in the mold base 20, and the two insert assemblies 30A, 30B are used to produce the left and right insoles of the same pair of shoes.

Between the first mold plate 21 and the respective insert assemblies 30 is provided a replaceable runner separating board 35 which is provided with a plurality of runners 351, so that material can be poured into the pouring gate of the first mold plate 21 and then flows through the runners 351 and into the respective insert assemblies 30.

Referring to FIGS. 3 and 4 again, the user can choose the insert assemblies 30A, 30B and assemble them on the mold base 20 based on manufacturing needs, as shown in the figures, the insert assemblies 30A, 30B fixed on the mold base 20 are used to produce the left and right insoles of the same pair of shoes.

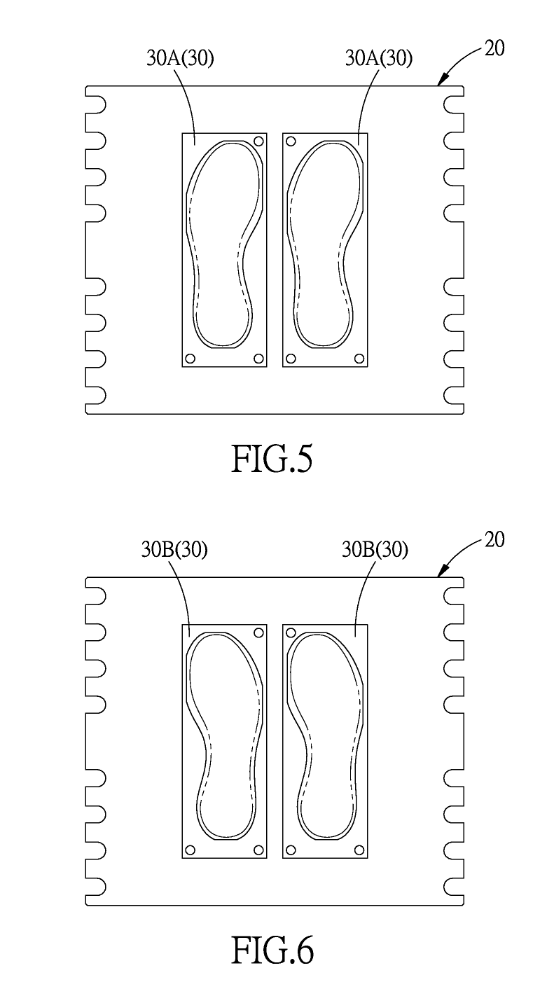

Referring then to FIGS. 5 and 6, the user can fix a plurality of identical insert assemblies 30 on the mold base 20 when only insoles of the same side need to be produced. Just as shown in FIG. 5, two insert assemblies 30A are fixed on the mold base 20 and used to produce two left insoles of the same size. Or, as shown in FIG. 6, two insert assemblies 30B are fixed on the mold base 20 and used to produce two right insoles of the same size.

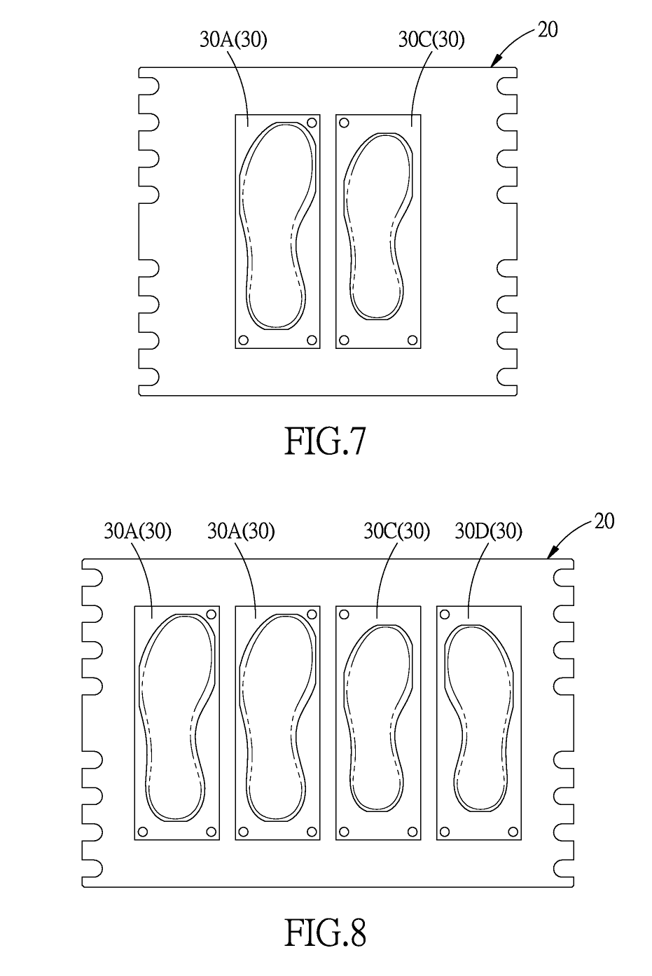

Besides, the mold base 20 of the present invention can also be used to produce insoles of different sizes at a time. For example, as shown in FIG. 7, two insert assemblies 30A and 30C of the same left side are fixed on the mold base 20. It is to be noted that the insert assemblies 30A, 30C have different sizes and are used to produce different sized insoles.

In addition to two insert assemblies 30, on the mold base 20 can also be provided plural insert assemblies 30. For example, as shown in FIG. 8, four insert assemblies 30A, 30C and 30D of different sizes are fixed on the mold base 20, which are three left-insole insert assemblies and one right-insole insert assembly. Hence, the insert assemblies 30 can be grouped freely and replaced easily according to different manufacturing needs to produce different products of different specifications, sizes or styles at a time.

While we have shown and described various embodiments in accordance with the present invention, it is clear to those skilled in the art that further embodiments may be made without departing from the scope of the present invention.

What is claimed is:

1. A mold assembly with a plurality of replaceable insert assemblies comprising:
a mold base with a first mold plate and a second mold plate;
each of the plurality of insert assemblies including a female insert and a male insert, at least two of the insert assemblies having their female inserts removably disposed at an inner side of the second mold plate of the mold base, and having their male inserts removably disposed at an inner side of the first mold plate.

2. The mold assembly with the plurality of replaceable insert assemblies as claimed in claim 1, wherein the mold base further includes a first connecting board and a second connecting board, the first mold plate is fixed to the first connecting board, and the second mold plate is fixed to the second connecting board.

3. The mold assembly with the plurality of replaceable insert assemblies as claimed in claim 1, wherein two of the insert assemblies are disposed in the mold base, and used to produce a left insole and a right insole of the same pair of shoes at a time.

4. The mold assembly with the plurality of replaceable insert assemblies as claimed in claim 1, wherein two of the insert assemblies are disposed in the mold base, and used to produce two left insoles of the same pair of shoes at a time.

5. The mold assembly with the plurality of replaceable insert assemblies as claimed in claim 1, wherein two of the insert assemblies are disposed in the mold base, and used to produce two right insoles of the same pair of shoes at a time.

6. The mold assembly with the plurality of replaceable insert assemblies as claimed in claim 1, wherein two of the insert assemblies are disposed in the mold base, and used to produce two insoles of different sizes at a time.

7. The mold assembly with the plurality of replaceable insert assemblies as claimed in claim 1, wherein the insert assemblies disposed in the mold base are used to produce two insoles of different sizes at a time.

8. The mold assembly with the plurality of replaceable insert assemblies as claimed in claim 1, wherein a replaceable runner separating board which is provided with a plurality of runners is disposed between the first mold plate and the respective insert assemblies.
